(19) United States
(12) Patent Application Publication
(10) Pub. No.: US 2005/0289279 A1
(43) Pub. Date: Dec. 29, 2005

(54) Power supply system and method thereof

(75) Inventors: Gary Fails, Tappan, NY (US); Lauren E. Dunn, New York, NY (US); Paul Kleissler, Englewood, NJ (US)

Correspondence Address: Moser, Patterson & Sheridan, LLP, Suite 100, 595 Shrewsbury Avenue, Shrewsbury, NJ, 07702, US

(73) Assignee: City Theatrical, Inc.

(21) Appl. No.: 11/109,012

(22) Filed: Apr. 18, 2005

Related U.S. Application Data
(60) Provisional application No. 60/582,695, filed on Jun. 24, 2004.

(51) Int. Cl. G06F 13/36

(52) U.S. Cl. 710/315

(57) ABSTRACT

A system and a method for operating devices (e.g., luminaries, light dimmers, effect devices, stepper motors, and the like) used in entertainment lighting applications is disclosed. Embodiments include a power supply operating a plurality of such devices coupled to selectively addressable outputs and having a converter of an industry-standard communication protocol (e.g., DMX512, RDM, or ACN protocol) in a communication protocol compatible with such devices.

### CROSS-REFERENCE TO RELATED APPLICATIONS

This application claims benefit of U.S. provisional patent application Ser. No. 60/582,695 filed Jun. 24, 2004, the entirety of which is herein incorporated by reference.

### BACKGROUND OF THE INVENTION

1. Field of the Invention

Embodiment of the present invention generally relate to entertainment lighting systems and, in particular, to methods and apparatus for powering devices used in entertainment lighting applications.

2. Description of the Related Art

Lighting systems used in entertainment applications such as stage shows, sport events, public gatherings, and the like have grown into complex and elaborate systems using broad varieties of stationary and moving lighting and effect devices.

In recent years, many lighting and effect devices have been computerized to improve functionality, operational performance, and serviceability of such systems. However, diversity and incompatibility of proprietary communication protocols used by manufacturers of specific devices (e.g., luminaries, dimmers, stepper motors, fog/smoke generators, and the like) makes it difficult, if not impossible, for using industry-standard communication protocols to be used for operating entertainment lighting and effects systems.

### SUMMARY OF THE INVENTION

Embodiments of the present invention are generally directed to a power supply system and a method for operating devices (e.g., stationary and moving luminaries, light dimmers, stepper motors, fog/smoke generators and other effect devices, and the like) used in entertainment lighting applications.

In one embodiment of the present invention, there is provided a computer-controlled power supply operating a plurality of lighting and effects devices (collectively referred to herein as a “controllable load” or “loads”). In one embodiment, the power supply is controlled using an industry-standard communication protocol (e.g., DMX512, RDM, or ACN protocol) and comprises a plurality of selectively addressable power/data outputs and a converter of the industry-standard communication protocol in the communication protocol compatible with the loads being operated.

In another embodiment of the present invention, there is provided a power supply system operating a plurality of the loads and comprising a controller using an industry-standard communication protocol (e.g., DMX512 protocol), the inventive power supply, and an optional configuration unit for remote programming of the power supply.

In yet another embodiment of the present invention, there is provided a method for using the inventive power supply and power supply system. The method includes addressing the power/data outputs of the power supply using an industry-standard communication protocol (e.g., DMX512 protocol); converting that protocol in the communication protocol compatible with the loads being operated; and selectively operating the loads using the communication protocol compatible with the loads.

### BRIEF DESCRIPTION OF THE DRAWINGS

So the manner in which the above recited features of embodiments of the present invention can be understood in detail, a more particular description of the present invention, briefly summarized above, may be had by reference to embodiments, some of which are illustrated in the appended drawings. It is to be noted; however, the appended drawings illustrate only typical embodiments of the present invention and are therefore not to be considered limiting of its scope, for the present invention may include other effective embodiments.

FIG. 1 is a high-level schematic diagram depicting a power supply system for entertainment lighting applications in accordance with one embodiment of the present invention; and

FIG. 2 is a flow diagram of a method for using the power supply system of FIG. 1 in accordance with an embodiment of the present invention.

To facilitate understanding, identical reference numerals have been used, where possible, to designate identical elements common to the figures.

### DETAILED DESCRIPTION

Embodiments of the present invention are generally directed to a power supply system and a method for operating electronically controllable loads used in entertainment lighting applications. Such applications may include theater, concert, museum, motion picture, television, sport event, public gathering, cruise ship, casino, amusement park lighting applications, and the like.

In the context of the present invention, the terms “controllable load” and “load” are used interchangeably in reference to lighting and effect devices used in the lighting applications and include stationary and moving luminaries, dimmers, stepper motors, fog/smoke generators, and the like. Hereafter, similar lighting and effect devices and power and data interfaces are identified using the same numeric references, except that suffixes may be added, when appropriate, to differentiate such devices and interfaces.

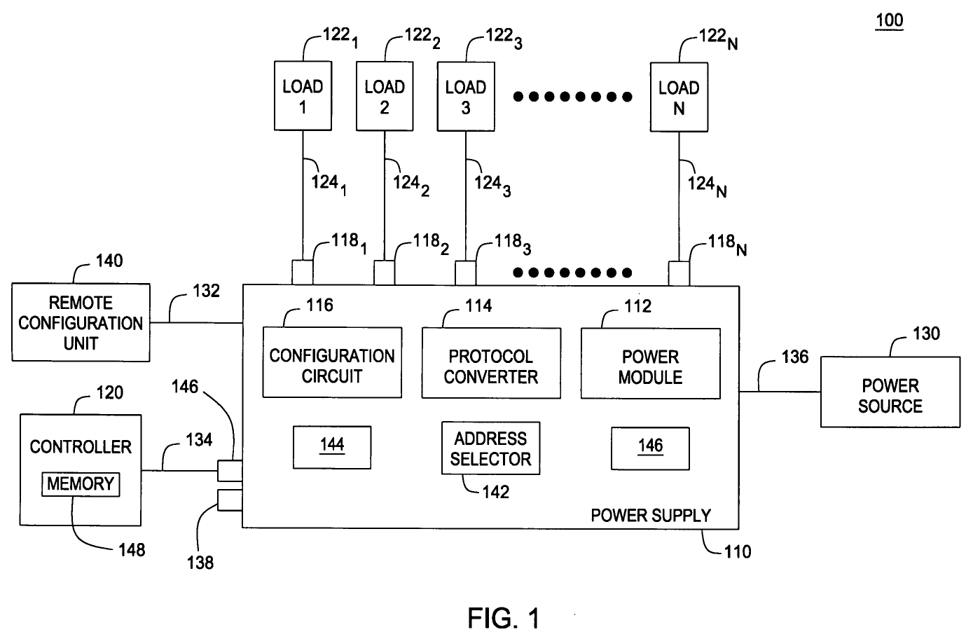

FIG. 1 is a high-level schematic diagram depicting a power supply system 100 for entertainment lighting applications in accordance with one embodiment of the present invention. The system 100 generally comprises a controller 120, a power source 130, a power supply 110 operating a plurality of N controllable loads 122 where N is an integer and N≧1, and an optional remote configuration unit 140.

The controller 120 is a specialized or general-purpose computer executing a predefined and/or interactive program of operating controllable loads used in lighting applications. Such a program may be stored in a memory device 148 of the controller 120 or a remote computer (not shown) coupled to the controller 120.

In operation, the controller 120 selectively controls each of the loads 122 via the power supply 110 using at least one of several industry-standard communication protocols. Instructions are communicated to the power supply 110 via an interface 134 compatible with the communication protocol being used.

In one exemplary embodiment, the controller 120 uses the DMX512 communication protocol developed by the U.S. Institute for Theater Technology, Inc. (USITT) Engineering Commission and adopted by the Entertainment Services and Technology Association (ESTA). In other embodiments, the controller 120 may use the Remote Device Management (RDM) protocol or the Advanced Control Network (CAN) protocol, both developed by ESTA.

The DMX512 protocol is a serial communication protocol that allows addressing 512 control, or data, channels per a data link and assigning, in a range from OFF to ON, up to 256 settings for each data channel. The data is transmitted, at up to 250 Kb/s, over two shielded wires using, for example, the RS-485 transmission standard. Each data channel corresponds to a controlled parameter of one of the loads 122 (e.g., setting of a dimmer, position of a stepper motor, and the like).

The power source 130 is generally a source of electricity at voltages that are within standardized ranges for the location of the lighting application that uses the power supply 110. In one embodiment, the power source 130 is an outlet of a local commercial power distribution network (e.g., 110/208 VAC network) and may conventionally be coupled to the power supply 110 using a power cable 136.

The power supply 110 is a computer-controlled modular DC or AC power supply. Power rating and format of output power of the power supply 110 may selectively be modified to meet the power requirements of the loads 122. In one embodiment, the power supply 110 is a 24 VDC power supply adapted for powering, e.g., lighting devices and/or similar loads.

In one embodiment, the power supply 110 generally comprises a power module 112, an address selector 142, a communication protocol converter 114, a configuration circuit 116, a plurality of addressable outputs 118, a pass-through connector 136 for coupling additional power supplies 110 (not shown) to the controller 120, a means 144 for industrial installation of the power supply, and an optional means 146 of load status indication.

The power module 112 converts electric power provided by the power source 130 in the power format compatible with the loads 122, as well as provides power required for functioning of components of the power supply 110. The converted DC or AC power (e.g., 24 VDC) is then provided to the addressable outputs 118.

The address selector 142 is used for assigning to the power supply 110 an address (i.e., data channel) compatible with the industry-standard communication protocol used by the controller 120. In one embodiment, the address selector 142 includes a bank of three binary coded decimal (BCD) switches and allows a user to assign any address, in a range from 000 to 511 that may be used by the DMX512 protocol. The BCD switches allow assigning such addresses in the field, without using any tools or programming. In a further embodiment, one address (e.g., address “000”) is reserved for a special control mode when all loads 122 are operated per instructions for the load 1221.

Because each of the loads 122 may have several controllable parameters (e.g., 2-5 or more parameters), a number of addresses allocated for the power supply 110 should be at least equal to or greater than the total number of the controllable parameters in the plurality of the loads 122 operated by the power supply. The address selector 142 typically assigns to the power supply 110 the smallest address in the range of addresses allocated for controlling that power supply and the loads and selectively assigns other addresses of that range to the loads 122.

The protocol converter 114 is an electronic device and/or a computer program executed by the power supply 120 that facilitate conversion of the industry-standard communication protocol used by the controller 120 (e.g., DMX512 protocol) in a communication protocol compatible with the loads 122. Such protocol conversion allows use of the power supply 110 for operating the loads 122 having proprietary or manufacturer-specific communication protocols.

The converter 114 effectively adapts the power supply 110 for operating practically any loads that may be used in entertainment lighting applications, as well as other computer-controlled applications. When the loads 122 are compatible with the communication protocol used by the controller 120, the converter 114 is optional.

The configuration circuit 116 selects data channels related to a specific load of a plurality of the loads 122 and directs such channels to the addressable output 118 pre-assigned to that load. Generally, the loads are cataloged, or identified, by assigning numeric identifiers related to a function and/or location of the load. The configuration circuit 116 associates each such identifier with one of the addressable outputs 118 and directs the data channels controlling the corresponding load to that addressable output.

In entertainment lighting applications, access to and identification of the loads may be difficult. The configuration circuit 116 allows a user to substitute a conventional routine of addressing the loads using unique coded digital sequences with assigning addressable outputs of the power supply 110 to the loads. The electrical connections to various loads may in situ be performed and/or modified by service personnel and do not require re-programming of the power supply 110.

In one embodiment, the addressable outputs 118 are integrated power/data connectors. In one embodiment, the power supply 110 comprises 12 addressable outputs 118. However, in other embodiments, the number of the outputs 118 may be either greater or smaller than 12. Each of the addressable outputs 118 is coupled to the power module 112 and provided with the DC or AC power compatible with the loads 122 (e.g., at 24 VDC), as well as coupled to the protocol converter 114 providing a control interface that is compatible with the communication protocol of the loads 122.

Such control interface includes the data channels (e.g., converted DMX512 data channels), which addresses correspond to the controllable parameters of the load coupled, via a power/data cable 124, to that addressable output. For example, the addressable output 118₁ is coupled to the data link including the channel(s) needed to operate the load 122₁; the addressable output 118₂ is coupled to the data link including the channel(s) needed to operate the load 122₂, and the like. In one embodiment, to increase reliability and noise immunity of the system 100, each addressable output is provided with an amplifier of the data signals.

The pass-through connector 136 duplicates the wiring diagram of an input connector 146 for the interface 134. Devices using the DMX512 protocol may be connected to the controller 120 using a daisy-chain technique. When a number of the loads 122 exceeds the number of addressable outputs 118 of a single power supply 110, additional power supplies 110 (not shown) may be added to the system 100 and coupled to the controller 120 using cables similar to the interface 134 and running between the connectors 138 and 146 of the respective power supplies 110.

The means 144 for industrial installation of the power supply 110 generally include at least one of a bracket for rack installation and a means for pipe mounting, as well as fixtures for desktop installation and stocking of the power supplies. In one embodiment, the optional means 146 of load status indication comprises a plurality of indicators (e.g., LED-based indicators), each indicator reporting on the operational status of the respective load 122.

In a further embodiment, the power supply system 100 includes the remote configuration unit 140 coupled to the power supply 120 using at least one of wired, wireless, and optical interface 132 (e.g., Universal Serial Bus (USB) cable). The remote configuration unit 140 is generally a portable or hand-held computer that facilitates remote control over the address selector 142 and configuration circuit 116. The unit 140 enables the assigning of the address to the power supply 110 and configuring addressable outputs 118 from a remote location, e.g., centralized command post of the entertainment lighting application.

In one embodiment, the controller 120 uses the DMX512 communication protocol to control twelve color-mixing light emitting diode based (LED-based) luminaries available from Color Kinetics, Inc. of Boston, Mass. To operate the luminaries, the power supply 120 converts the DMX512 protocol in the manufacturer's proprietary communication protocol. Each of the luminaries requires providing 24 VDC and three data channels and is coupled to a respective addressable output of the power supply 110. In other embodiments, the power supply 110 may have either more or less than twelve addressable outputs and provide either more or less than three data channels per the addressable output, as well as operate other loads requiring the same or different supply voltages.

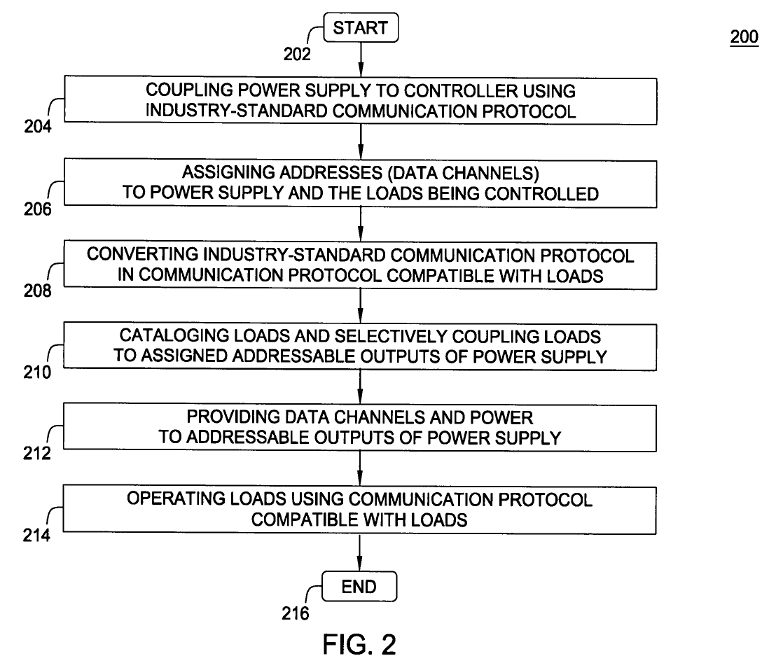

FIG. 2 is a flow diagram of a method 200 for using the power supply system 100 of FIG. 1 in accordance with one embodiment of the present invention. The method 200 illustratively includes the processing steps that are performed to operate the loads 122 controlled using a proprietary communication protocol. To best understand this embodiment of the present invention, reference is made to FIGS. 1 and 2.

The method 200 starts at step 202 and proceeds to step 204. At step 204, the power supply 110 is coupled to the controller 120 that uses an industry-standard communication protocol (e.g., DMX512 protocol) to operate an exemplary plurality of twelve controllable loads 122 (e.g., LED-based luminaries). Illustratively, in the DMX512 data link between the controller 120 and the power supply 110, the addresses (or data channels) are assigned to each luminary.

At step 206, addresses (data channels) used by the industry-standard communication protocol are assigned to the power supply 110 and the loads 122. These addresses may be assigned using the address selector 142 of the power supply 110 and/or the remote configuration unit 140, as discussed in detail above in reference to FIG. 1.

At step 208, using the protocol converter 114 of the power supply 110, the industry-standard communication protocol used by the controller 120 (i.e., DMX512 protocol) is converted in the communication protocol compatible with the loads 122 (e.g., communication protocol of the referred to above color-mixing LED-based luminaries of Color Kinetics, Inc.).

At step 210, the loads 122 are cataloged (e.g., by location of the load during the lighting application), each load is assigned to a specific addressable output 118 of the power supply 110 and selectively coupled to that output using a power/data cable (i.e., cable adapted for transmitting both data and power signals).

At step 212, using the configuration circuit 116 of the power supply 110, data channel(s) corresponding to each specific load 122 is (are) selectively directed to the addressable output 118 that is assigned to that load. Additionally, the addressable outputs 118 are coupled to the power module 112 and provided with the DC or AC power compatible with the loads 122 (e.g., at 24 VDC).

At step 214, during the lighting application, the loads 122 are selectively operated using the power supply 110 per a program executed by the controller 120. At step 216, upon completion of the lighting application, the method 200 ends.

While the foregoing is directed to embodiments of the present invention, other and further embodiments of the present invention may be devised without departing from the basic scope thereof, and the scope thereof is determined by the claims that follow.

1. A power supply, comprising:
a plurality of selectively addressable outputs, each output adapted for coupling to a load of a plurality of such loads;
an input for an industry-standard communication protocol, and
a converter of the industry-standard protocol in a communication protocol compatible with the loads.

2. The power supply of claim 1 wherein each output comprises a means for providing power interface and control interface to a load.

3. The power supply of claim 1 wherein each output is assigned N data channels of the industry-standard communication protocol, where N is an integer and N≧1.

4. The power supply of claim 1 wherein the loads are selected from a group consisting of luminaries, light dimmers, effect devices, and stepper motors.

5. The power supply of claim 4 wherein the luminaries are color-mixing light emitting diode based (LED-based) luminaries.

6. The power supply of claim 1 wherein the industry-standard communication protocol is selected from a group consisting of the DMX512 protocol, the Remote Device Management (RDM) protocol, and the Advanced Control Network (ACN) protocol.

7. The power supply of claim 6 wherein the power supply converts the industry-standard communication protocol in a communication protocol compatible with the loads.

8. The power supply of claim 6 further comprising a pass-through connector for the industry-standard communication protocol.

9. The power supply of claim 6 further comprising a means for assigning to the power supply an address compatible with the industry-standard communication protocol.

10. The power supply of claim 9 wherein the means comprises at least one BCD switch.

11. The power supply of claim 1 further comprising a means for desktop, rack, and/or rail installation for the power supply.

12. The power supply of claim 1 wherein the power supply is a portion of a power supply system further comprising a configuration unit for assigning to the power supply and/or compatible with an industry-standard communication protocol and assigning the addressable output to the loads.

13. The power supply of claim 12 wherein the configuration unit is coupled to the power supply using at least one of wired, wireless, and optical interfaces.

14. A power supply system, comprising:
a controller used with an industry-standard communication protocol;
a plurality of controllable loads; and
at least one power supply of claim 1 coupled to the controller, wherein:
each of the addressable outputs is addressed using the industry-standard communication protocol and selectively coupled to one of the loads; and
the converter converts the industry-standard communication protocol in a communication protocol compatible with the loads.

15. The power supply system of claim 15 further comprising a configuration unit assigning to the least one power supply and/or the addressable outputs thereof the addresses compatible with the industry-standard communication protocol.

16. The power supply system of claim 15 wherein the industry-standard communication protocol is selected from a group consisting of the DMX512 protocol, the Remote Device Management (RDM) protocol, and the Advanced Control Network (ACN) protocol.

17. A power supply system, comprising:
a controller using the DMX512 communication protocol;
a plurality of LED-based luminaries; and
at least one power supply of claim 1 coupled to the controller, wherein:
each of the addressable outputs is addressed using the DMX512 communication protocol and selectively coupled to one of the luminaries; and
the converter converts the DMX512 communication protocol in a communication protocol compatible with the luminaries.

18. A method for operating a plurality of controllable loads, comprising:
providing a power supply having a plurality of selectively addressable outputs, each of the outputs adapted for coupling to one of the loads;
addressing the power supply and/or the outputs using an industry-standard communication protocol;
converting the industry-standard communication protocol in a communication protocol compatible with the loads; and
selectively operating the loads using the communication protocol compatible with the loads.

19. The method of claim 18 wherein each of the outputs comprises a means for providing power interface and control interface to a load.

20. The method of claim 18 wherein each of the outputs is assigned N data channels of the industry-standard communication protocol, where N is an integer and N≧1.

21. The method of claim 18 wherein the loads are selected from a group consisting of luminaries, light dimmers, effect devices, and stepper motors.

22. The method of claim 18 wherein the luminaries are color-mixing light emitting diode based (LED-based) luminaries.

23. The method of claim 18 wherein the industry-standard communication protocol is selected from a group consisting of the DMX512 protocol, the Remote Device Management (RDM) protocol, and the Advanced Control Network (ACN) protocol.
